(19) United States
(12) Patent Application Publication
(10) Pub. No.: US 2024/0109025 A1
(43) Pub. Date: Apr. 4, 2024

(54) COMPOSITE MATERIALS FOR WATER CAPTURE AND RELEASE

(71) Applicant: National University of Singapore, Singapore (SG)

(72) Inventors: Dan Zhao, Singapore (SG); Avishek Karmakar, Singapore (SG); Shing Bo Peh, Singapore (SG)

(21) Appl. No.: 17/754,509

(22) PCT Filed: Oct. 9, 2020
(86) PCT No.: PCT/SG2020/050575

§ 371 Date: Apr. 4, 2022

(30) Foreign Application Priority Data
Oct. 17, 2019 (SG) 10201909679U

(51) Int. Cl. B01D 53/28; B01D 53/02; B01D 53/26; B01J 20/22; B01J 20/26; B01J 20/32; B01J 20/34; E03B 3/28

(52) U.S. Cl. CPC B01D 53/28; B01D 53/02; B01D 53/261; B01J 20/226; B01J 20/264; B01J 20/3204; B01J 20/3272; B01J 20/3425; B01J 20/3483; E03B 3/28; B01D 2253/202; B01D 2253/204; B01D 2253/25; B01D 2257/80; B01D 2258/06; B01D 2259/40088

(57) ABSTRACT

Disclosed herein is a composite material comprising: a plurality of water-stable metal-organic frameworks, each having a plurality of porous cavities; and a temperature-sensitive polymeric material in the form of polymer chains, wherein the polymer chains of the temperature-sensitive polymeric material are formed at least partly within the porous cavities of the plurality of water-stable metal-organic frameworks. Also disclosed herein is the use of said composite material for adsorption and release of water.

### FIELD OF INVENTION

The current invention relates to composite materials comprising water-stable metal-organic frameworks and a temperature-sensitive polymeric material, and the use of said composite materials for water capture and release.

### BACKGROUND

The listing or discussion of a prior-published document in this specification should not be necessarily be taken as an acknowledgement that the document as part of the state of the art or is common general knowledge.

The shortage of clean water is a serious and enduring global issue, which not only concerns human health, but also climate change and energy security due to the inter-dependence of water and energy production (i.e. the “water-energy nexus). As such, there is a great interest in developing energy-efficient technologies to collect and generate water.

Atmospheric water constitutes a major untapped resource of fresh water that may be used to mitigate water shortages. Biological creatures like Namib Desert beetles and spiders have the ability to harvest such atmospheric water (through fog/dew water collection) by exploiting hydrophobic-hydrophilic interactions (between their body structures and water), which have been emulated in some synthetic biomimetic materials. Although fog- and dew-harvesting are promising methods of atmospheric water harvesting (AWH), their high cost, fragility and susceptibility to extreme weather conditions remain as critical challenges.

Metal-organic frameworks (MOFs) have been recently identified as promising sorbent materials for water-related applications including adsorption heat pumps (AHPs), atmospheric water generators (AWGs), water harvesting and dehumidification. Mesoporous MOFs such as the water-stable MIL-101(Cr) (MIL=Materials of Institut Lavoisier) have shown considerable water uptake capacities (≥1 g g⁻¹). Some other water-stable Zr-based MOFs have also been demonstrated in AWH and refrigeration applications due to their ability to avoid undesired sorption hysteresis. However, most MOFs need to be regenerated at temperatures higher than 80° C. to regain performance after water adsorption, which are not energy efficient.

As such, there is a need to develop new composite materials to address one or more of the problems mentioned above. Importantly, these composite materials must exhibit high water uptake/release capacity within their working pressure range, and have moderate regeneration temperature (i.e. ideally, at temperatures lower than 50° C. to allow the use of low grade heat and even renewable energy resources such as solar energy). Further, such materials must be highly versatile and functional, and be easy and cheap to produce in large quantities.

Thermo-responsive polymers, which allow the control of hydrophilicity/hydrophobicity by temperature, have attracted wide research interest as smart materials, especially for biological applications. Among those, poly(N-isopropylacrylamide) (PNIPAM) exhibits an interesting coil-to-globular (hydrophilic-to-hydrophobic) conformational change above its lower critical solution temperature (LCST) of ca. 33° C.

### SUMMARY OF INVENTION

1. A composite material comprising:
a plurality of water-stable metal-organic frameworks, each having a plurality of porous cavities; and a temperature-sensitive polymeric material in the form of polymer chains, wherein
the polymer chains of the temperature-sensitive polymeric material are formed at least partly within the porous cavities of the plurality of water-stable metal-organic frameworks.

2. The composite material according to Clause 1, wherein each polymer chain extends through one or more of the plurality of cavities in a single metal-organic framework.

3. The composite material according to Clause 1 or Clause 2, wherein a portion of the polymer chains extend from one or more cavities in a single metal-organic framework and into one or more cavities of at least one further metal-organic framework.

4. The composite material according to any one of the preceding clauses, wherein at least part of one or more (e.g. two or three) polymer chains occupy the same cavity of a metal-organic framework.

5. The composite material according to any one of the preceding clauses, wherein the water-stable metal-organic framework is formed from one or more of the group consisting of MOF-801, MOF-841, UiO-66, PIZOF-2, MIL-100(Fe), MIL-101(Al), MIL-125-NH₂, Co₂Cl₂(BTDD), Y-shp-MOF-5, and MIL-101(Cr) (e.g. the water-stable metal-organic framework is formed from one or more of the group consisting of MIL-100(Fe), MIL-101(Al), MIL-125-NH₂, Co₂Cl₂(BTDD), Y-shp-MOF-5, and MIL-101(Cr)).

6. The composite material according to any one of the preceding clauses, wherein the water-stable metal-organic framework is MIL-101(Cr).

7. The composite material according to any one of the preceding clauses, wherein the temperature-sensitive polymeric material is selected from one or more of the group consisting of polyethylene oxide (PEO), poly(ethylene oxide-co-propylene oxide) (poly(EO/PO) copolymers), PEO-PPO-PEO triblock surfactants, alkyl-PEO block surfactants, poly(vinyl methyl ether) (PVME), poly(oxyethylene vinyl ether) (POEVE), polymeric alcohols, hydroxypropyl acrylate, hydroxypropyl methylcellulose, hydroxypropyl cellulose, methylcellulose, poly(vinyl alcohol) and derivatives, polyamides, poly(N-vinyl pyrrolidone), poly(ethyl oxazoline), poly(N-vinylisobutylamide) (PNVIBA), poly(2-carboxyisopropylacrylamide) (PCIPAAm), poly(methacrylic acid), artificial polypeptides, triblock co-polypeptides that consist of short “leucine zipper” end blocks, elastin-like polypeptides (ELPs), and poly(N-isopropylacrylamide).

8. The composite material according to any one of Clauses 1 to 6, wherein the temperature-sensitive polymeric material is selected from one or more of the group consisting of a poly(N-vinylamide) and a polyacrylic acid, or a derivative of a polyacrylic acid.

9. The composite material according to Clause 8, wherein the poly(N-vinylamide) is selected from one or more of the group consisting of poly(N-vinyl pyrrolidone), poly(N-vinylisobutylamide) (PNVIBA), and poly(2-carboxyisopropylacrylamide).

10. The composite material according to Clause 8, wherein the polyacrylic acid is selected from one or more of polyacrylic acid and poly(methacrylic acid).

11. The composite material according to Clause 8, wherein the polyacrylic acid derivative is a polyacrylamide.

12. The composite material according to Clause 11, wherein the polyacrylamide is selected from one or more of poly(N-isopropylacrylamide), and poly(N,N-diethylacrylamide).

13. The composite material according to any one of the preceding clauses, wherein the temperature-sensitive polymeric material is poly(N-isopropylacrylamide).

14. The composite material according to any one of the preceding clauses, wherein the water-stable metal-organic framework is MIL-101(Cr) and the temperature-sensitive polymeric material is poly(N-isopropylacrylamide).

15. The composite material according to any one of the preceding clauses, wherein the temperature-sensitive polymeric material forms from 20 to 95 wt % of the total dry weight of the composite material, such as from 38 to 85 wt %.

16. The composite material according to any one of the preceding clauses, wherein the composite material can adsorb a maximum of from 100 to 440 wt % of water relative to the dry weight of the composite material when exposed to saturated humid air conditions for a period of 24 hours.

17. Use of a composite material as described in any one of Clauses 1 to 16 for adsorption and release of water.

18. The use of Clause 17, wherein the adsorption of water is the adsorption of atmospheric water.

19. A method of obtaining water from the atmosphere, comprising the steps of:
(a) providing a composite material according to any one of Clauses 1 to 16 to ambient atmospheric conditions for a period of time to adsorb water from the atmosphere; and
(b) heating the composite material to a temperature of from 5 to 20° C. above the lower critical solution temperature of the temperature-sensitive polymeric material to obtain water.

20. The method according to Clause 19, wherein the heating in step (b) is from 7 to 15° C. above the lower critical solution temperature of the temperature-sensitive polymeric material.

### BRIEF DESCRIPTION OF DRAWINGS

FIG. 1 Depicts a schematic illustration of the preparation of the MOF/polymer composite material 30 of the current invention (using a porous MOF 10 and monomers 20), and the temperature-triggered water capture and release process by said material 30. LCST=lower critical solution temperature.

FIG. 2 Depicts in-situ polymerisation of NIPAM inside the porous voids of MIL-101(Cr) via free radical polymerisation to form PNIPAM.

FIG. 3 Depicts: (a) FTIR spectra of MIL-101(Cr), PNIPAM@MIL-101(Cr)-1, and PNIPAM; (b) XPS spectra of MIL-101(Cr) and PNIPAM@MIL-101(Cr)-1; (c) N₂ sorption isotherms at 77 K of MIL-101(Cr) and PNIPAM@MIL-101(Cr) 1-4 (adsorption, filled; desorption, open); and (d) TEM images of PNIPAM@MIL-101(Cr) 1-4.

FIG. 4 Depicts the PXRD patterns of: (a) as-made MIL-101(Cr) and activated MIL-101(Or); and (b) NIPAM@MIL-101(Cr)-1, PNIPAM@MIL-101(Cr) 1-4, and MIL-101(Cr).

FIG. 5 Depicts the FTIR spectra of: (a) MIL-101(Cr), NIPAM@MIL-101(Cr)-1, PNIPAM@MIL-101(Cr)-1, as-made PNIPAM, and PNIPAM extracted from PNIPAM@MIL-101(Cr)-1; (b) MIL-101(Cr), NIPAM@MIL-101(Cr)-1, PNIPAM@MIL-101(Cr) 1-4, and as-made PNIPAM.

FIG. 6 Depicts the ¹H-NMR spectrum of the PNIPAM extracted from PNIPAM@MIL-101(Cr)-1.

FIG. 7 Depicts the GPC profiles of the as-made PNIPAM and the PNIPAM extracted from PNIPAM@MIL-101(Cr)-1.

FIG. 8 Depicts the pore size distributions of PNIPAM@MIL-101(Cr)-1-4.

FIG. 9 Depicts the TGA profiles of MIL-101(Cr), NIPAM@MIL-101(Cr)-1, PNIPAM@MIL-101(Cr)-1, and as-made PNIPAM.

FIG. 10 Depicts the SEM images of PNIPAM@MIL-101(Cr) 1-4 showing uniform crystalline morphologies.

FIG. 11 Depicts: (a-c) the water sorption isotherms of various samples at 25° C. (a, b) and 40° C. (c), respectively. Adsorption, filled; desorption, open; and (d) DSC profiles of MIL-101(Or), PNIPAM, NIPAM@MIL-101(Cr)-1, and PNIPAM@MIL-101(Cr)-1.

FIG. 12 Depicts the water uptake and release properties of the current invention: (a) water uptakes of PNIPAM, MIL-101(Cr), and PNIPAM@MIL-101(Cr)-1 under various conditions (96% RH for 25° C., 40% RH for 40 and 50° C.); (ai) represents the initial data, while (aii) shows the finalised data; (b) water uptake and release kinetics data of PNIPAM@MIL-101(Cr)-1 collected using a humidity chamber. The uptake test was conducted by saturating the sample to wet state (solid symbols). The release test was conducted by exposing the saturated sample to dry state (empty symbols); (c) water uptakes (represented by *, taken under wet state) and water release (represented by \hat{ }, defined as the difference of water uptakes between wet and dry states) of PNIPAM@MIL-101(Cr)-1, MIL-101(Cr), and PNIPAM; (ci) represents the initial data, while (cii) shows the finalised data; (d) cyclic water uptakes of PNIPAM@MIL-101(Cr)-1 between wet and dry states; and (ei) photos of PNIPAM@MIL-101(Cr)-1 under wet (96% RH and 25° C.) or dry (40% RH and 40° C.) state. The optical image in (eii) shows the PNIPAM@MIL-101(Cr)-1 particles after exposure to 96% RH at 25° C., and (eiii) shows the optical image after exposure to 40% RH and 40° C.

FIG. 13 Depicts: (a) initial; and (b) subsequent studies on the water uptakes of various samples upon exposure to 96% RH at 25° C. in the humidity chamber. The percentages water uptake of the samples are listed in Table 3.

FIG. 14 Depicts the water uptake and release kinetics data of various sample collected using a humidity chamber: (a) MIL-101(Cr); (b) PNIPAM; (c) PNIPAM@MIL-101(Cr)-2; (d) PNIPAM@MIL-101(Cr)-3; and (e) PNIPAM@MIL-101(Cr)-4. The uptake test was conducted by saturating the sample to 96% RH at 25° C. (solid symbols). The release test was conducted by exposing the saturated sample to 40% RH at 40° C. (empty symbols).

FIG. 15 Depicts the molecular dynamics (MD) simulations of the PNIPAM polymer chains in the pores of the MIL-101(Cr). The preferential distribution of PNIPAM in the cages of MIL-101(Cr) for a polymer content of 19.7 wt. % and 59.0 wt. % are as shown in (a, b) and (c, d), respectively: (a) and (c) correspond to views of the small cages; (b) and (d) correspond to views of the large cages. The metal centers of the MOFs are represented as polyhedra. As demonstrated previously by Kitagawa et al. that the nature of the counter anions (—OH, —F, —SO₄, etc.) has only a small impact on the overall adsorption behaviour of MIL-100s (G. Akiyama, et al., Chem. Lett. 2010, 39, 360-361); therefore, all the simulations were done using the original MIL-101(Cr) crystal structure reported by Férey et al. containing —F as representative counter anion (G. Férey, et al., Science 2005, 309, 2040-2042). The PNIPAM molecules can be represented in linear (e) or curled (f) conformations.

FIG. 16 Depicts the labels associated to the different atom types of: (a) MIL-101(Cr); and (b) PNIPAM from the MD simulations. In PNIPAM, two labels were adopted, one according to the atoms' charges and another (in brackets) following the OPLS-AA notation.

FIG. 17 Depicts the radial distribution functions (RDFs) obtained from a MD simulation of a 19.7 wt. % PNIPAM@MIL-101(Cr) system: (a) the RDFs relative to the counter-anion-H(NH), O(CO)—H(H₂O), and C_{C3}-C_{CT} atom pairs representing the main PNIPAM/MIL-101(Cr) interactions; and (b) the RDF assigned to the O(CO)—H(NH) atom-pair illustrating the main mutual PNIPAM interactions. Further details on the atomic types are discussed in Example 4 and FIG. 16.

FIG. 18 Depicts the RDFs relative to the interaction between the atom pairs: (a) F—H(NH); (b) O(CO)—H(H₂O); (c) CT-C3; and (d) O(CO)—H(NH) obtained from MD simulations of 19.7 wt. % (solid line) and 59.0 wt. % (dashed line) PNIPAM@MIL-101(Cr) systems.

FIG. 19 Depicts the average radius of gyration of all the PNIPAM molecules in the pores of the MIL-101(Cr) (black line and circles) in hydrated conditions compared to the average individual radius of gyration of the molecules (empty circles) throughout the simulation.

FIG. 20 Depicts the RDFs relative to the interactions between: (a) F—H(NH); (b) O(CO)—H(H₂O); and (c) C_{C3}-C_{CT} atom pairs obtained from a MD simulation of the 59.0 wt. % PNIPAM@MIL-101(Cr) system at the anhydrous and fully hydrated states.

FIG. 21 Depicts the molecular dynamics (MD) simulations of the PNIPAM@MIL-101(Cr) in the presence of water. The preferential location of PNIPAM (a, c) and water (b, d) in the small (a, b) and large (c, d) cages of the MIL-101(Cr) for a polymer content of 59.0 wt. % are as shown accordingly. The metal centers of the MOFs are represented as polyhedra; (e) RDFs showing the interactions of the oxygen atoms in the water molecules (O_{w}) and the O(H₂O) and F atoms of the framework, as well as the interaction of the O_{w} with the N and O atoms of the PNIPAM molecules; and (f) a representative snapshot showing the hydrogen-bonds (dashed lines) formed between the water molecules and the amide groups of a PNIPAM chain.

FIG. 22 Depicts the RDF of the O_{w}—O_{w} interacting pair in a water-saturated PNIPAM@MIL-101(Cr) system containing 59.0 wt. % of PNIPAM.

FIG. 23 Depicts the number of hydrogen bonds per hydrophilic atom of: (a) MIL-101(Cr); (b) PNIPAM; and (c) H₂O. In (a), N_{H-bond} is measured per F and O(H₂O) atoms; in (b), N_{H-bond} is measured per N(NH) and O(CO) atoms; and in (c), N_{H-bond} is measured per H₂O molecules.

FIG. 24 Depicts the unwrapped PNIPAM chains distribution within the pores of the fully hydrated MIL-101(Cr) at PNIPAM loadings of: (a) 19.7 wt. %; (b) 39.4 wt. %; (c) 59.0 wt. %; and (d) 78.7 wt. %. Each color represents a distinct polymer chain.

FIG. 25 Depicts the mean square displacement (MSD) of water molecules in the saturated MIL-101(Cr) (dashed line) and PNIPAM@MIL-101(Cr) systems with 19.7 wt. %, 39.4 wt. %, 59.0 wt. %, and 78.7 wt. % of PNIPAM.

### DESCRIPTION

In a first aspect of the invention, there is provided a composite material comprising:
a plurality of water-stable metal-organic frameworks, each having a plurality of porous cavities; and
a temperature-sensitive polymeric material in the form of polymer chains, wherein the polymer chains of the temperature-sensitive polymeric material are formed at least partly within the porous cavities of the plurality of water-stable metal-organic frameworks.

The word “comprising” refers herein may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

As will be appreciated, each of the metal-organic frameworks (MOFs) mentioned herein are materials that comprise bonds (i.e. coordination bonds) between metal cations and multidentate organic linkers, and they form a porous structure with a plurality of cavities within each MOF.

Any MOF that is water-stable may be used herein, provided that they contain cavities that can accommodate polymer chains that can be formed within (and between) said cavities.

Examples of suitable MOFs include, but are not limited to:
a) MOF-801;
b) MOF-841;
c) UiO-66;
d) PIZOF-2;
e) MIL-100(Fe);
f) MIL-101(Al);
g) MIL-125-NH₂;
h) Co₂Cl₂(BTDD);
i) Y-shp-MOF-5; and
j) MIL-101(Cr).

Thus, the water-stable metal-organic framework may be formed from one or more of the group consisting of MOF-801, MOF-841, UiO-66, PIZOF-2, MIL-100(Fe), MIL-101(Al), MIL-125-NH₂, Co₂Cl₂(BTDD), Y-shp-MOF-5, and MIL-101(Cr).

Particular MOFs that may be mentioned in embodiments herein include, but are not limited to MIL-100(Fe), MIL-101(Al), MIL-125-NH₂, Co₂Cl₂(BTDD), Y-shp-MOF-5, and MIL-101(Cr), such as MIL-100(Fe), MIL-101(Al), and MIL-101(Cr). For example, the MOF may be MIL-101(Cr).

When used herein, the term “water-stable metal-organic frameworks” refers to a MOF material that remains substantially unaltered for an extended period of time when exposed to (or immersed in) an aqueous environment at or around neutral pH (e.g. from pH 6 to 8, such as about pH 7). For example, the period of time may be from 1 day to 10 years, such as from 10 days to 5 years, such as from 1 month to 1 year, such as from 2 months to 6 months. The term “substantially unaltered” when used herein may refer to at least 60 wt %, such as at least 70 wt %, such as at least 80 wt %, such as at least 90 wt %, such as at least 99 wt %, such as at least 99.9 wt %, such as at least 99.999 wt % of the MOF portion of the composite material remaining in an unaltered form over the relevant period of time.

Without wishing to be bound by theory, the MOFs disclosed herein may be particularly useful for the formation of the desired composite materials because they have one of more (e.g. all) of the following properties.
a) High hydrolytic stability.
b) High thermal stability.
c) Excellent water uptake characteristics.
d) Typical S-shaped isotherm in the water adsorption which makes it a suitable candidate for atmospheric water generation (AWG) applications.
e) High BET surface area which makes it suitable for polymerisation to occur inside the porous matrix of the MOF (i.e. within the cavities of the MOF).

As will be appreciated, the MOF disclosed herein also withstand (or are expected with withstand) the conditions used to conduct the polymerisation reaction and the subsequent work-up steps to provide the composite material. This may be because the conditions used for the polymerisation are mild (e.g. at a pH of from 6 to 8 or under neutral pH conditions), or it may be because the MOF can survive in harsher conditions where the pH is more acidic (e.g. from 1 to 5, such as from 2 to 4, such as 3) or where the pH is more basic (e.g. from 9 to 11, such as 10).

Temperature-sensitive polymeric materials that may be useful in the current invention may be a polymer that has a low value for its lower critical solution temperature (LCST). For example, the LCST value may be from 20 to 85° C., such as from 25 to 50° C., such as from 28 to 37° C., such as 30 to 34° C., such as 32° C. For the avoidance of doubt, it is explicitly contemplated that where a number of numerical ranges related to the same feature are cited herein, that the end points for each range are intended to be combined in any order to provide further contemplated (and implicitly disclosed) ranges. Thus, in relation to the above related numerical ranges, there is disclosed:
from 20 to 25° C., from 20 to 28° C., from 20 to 30° C., from 20 to 32° C., from 20 to 34° C., from 20 to 37° C., from 20 to 50° C., from 20 to 85° C.;
from 25 to 28° C., from 25 to 30° C., from 25 to 32° C., from 25 to 34° C., from 25 to 37° C., from 25 to 50° C., from 25 to 85° C.;
from 28 to 30° C., from 28 to 32° C., from 28 to 34° C., from 28 to 37° C., from 28 to 50° C., from 28 to 85° C.;
from 30 to 32° C., from 30 to 34° C., from 30 to 37° C., from 30 to 50° C., from 30 to 85° C.;
from 32 to 34° C., from 32 to 37° C., from 32 to 50° C., from 32 to 85° C.;
from 34 to 37° C., from 34 to 50° C., from 34 to 85° C.;
from 37 to 50° C., from 37 to 85° C.; and from 50 to 85° C.

Particularly preferred polymeric materials that may be mentioned herein may have a LCST value of 30° C. or greater (e.g. from 30° C. to 50° C.). As such, the following temperature ranges may be mentioned in embodiments herein:
from 30 to 32° C., from 30 to 34° C., from 30 to 37° C., from 30 to 50° C.;
from 32 to 34° C., from 32 to 37° C., from 32 to 50° C.;
from 34 to 37° C., from 34 to 50° C.; and from 37 to 50° C.

Polymers that may be useful in the current invention may be polymers that have a low LCST value, and which are made from monomeric materials that are readily amenable to the synthesis of polymer chains within the cavities of the MOFs described hereinbefore. As an example, PNIPAM may be a suitable polymer for incorporation into the desired composite products because it has a low LCST value (which makes it a suitable candidate to impart thermo-responsive behaviour in the composites) and it is easy to synthesise PNIPAM from its monomeric constituents in the porous cavities of a MOF (e.g. MIL-101(Cr)). A table showing some of the other thermo-responsive having interesting LCST behaviour is shown in table 1 (reproduced from Asian journal of pharmaceutical sciences 10(2015) 99-107).

As noted in the examples above, the water capture by the composites disclosed herein is done at a RH>95%, which denotes an oversaturated vapor pressure of water. The release phenomenon for the composites exemplified is observed starting from 40° C. which is ˜7° C. above the LCST of PNIPAM.

TABLE 1
Selected polymers with LOST or UCST behaviour in the temperature
region relevant for biomedical applications.

| | |
|---|---|
| | Phase transition temperature |
| Polymer | in aqueous solution |

LCST behaviour:

| | | |
|---|---|---|
| Poly(N-isopropylacrylamide) | 30-34° | C. |
| Poly(N,N-diethylacrylamide) | 32-34° | C. |
| Poly(methyl vinyl ether) | 37° | C. |
| Poly(N-vinylcaprolactam) | 30-50° | C. |
| Block copolymer of poly(ethylene oxide) | 20-85° | C. |
| and poly(propylene oxide)s | | |
| Poly(pentapeptide) of elastin | 28-30° | C. |

UCST behaviour:

| | | |
|---|---|---|
| Polyacrylamide and polyacrylic acid IPN | 25° | C. |

For the avoidance of doubt, all materials listed in table 1 above may be used as the polymer in the composite materials discussed herein. For the avoidance of doubt, this also applies to the inter-penetrating network material in the table above.

As noted above, the composite material incorporates a polymeric material into the cavities of the MOF. In some cases, a polymeric chain may be entirely contained within a cavity of the MOF. However, in other cases, a polymer chain may be partly housed within one cavity of the MOF and extend out from that cavity, such that part of the polymer chain is not housed at all. In yet further cases, a polymer chain may extend through one cavity and into at least one further cavity in the same MOF. It will be appreciated that the vast majority (e.g. >90%, such a >85%, such as >99%, such as >99.9%, such as >99.999%, such as all) of the polymer chains found in the composite materials will extend through one or more cavities in a single MOF, though it will be understood that a proportion of the polymer chains in the composite material may fall into the other situations mentioned above. As will also be appreciated, one or more polymer chains (e.g. two, three, four or five, such as two or three) may occupy the same cavity in a metal-organic framework.

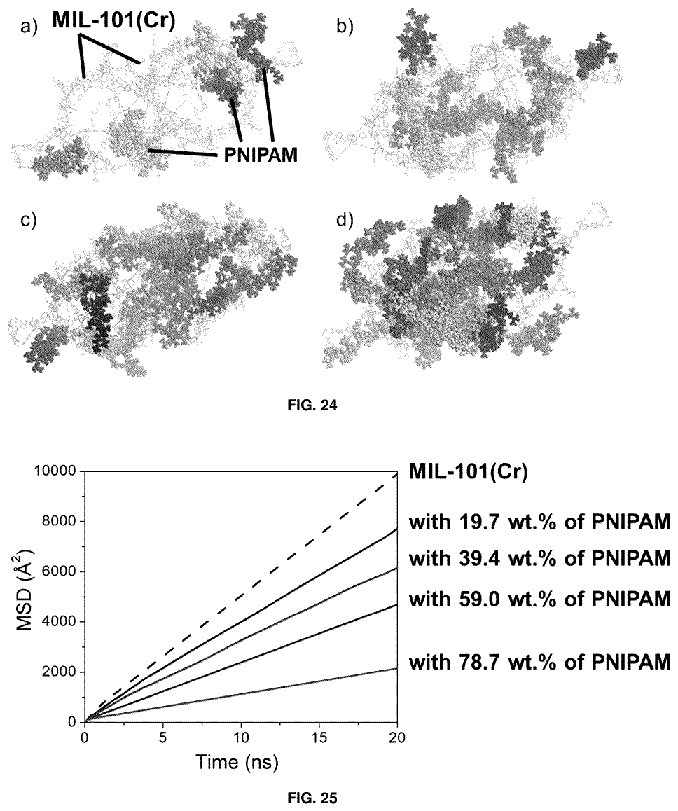

In certain embodiments of the composite material that may be mentioned herein, a portion of the polymer chains extend from one or more cavities in a single metal-organic framework and into one or more cavities of at least one further metal-organic framework (see FIGS. 24a-d). As will be appreciated, each MOF forms an individual unit (comprising of one or more unit cells, or repeating units, of the MOF), and these units may be connected together by one or more polymer chains extending from one unit to the other.

Particular temperature-sensitive polymeric material may be selected from one or more of the group consisting of polyethylene oxide (PEO), poly(ethylene oxide-co-propylene oxide) (poly(EO/PO) copolymers), PEO-PPO-PEO triblock surfactants, alkyl-PEO block surfactants, poly(vinyl methyl ether) (PVME), poly(oxyethylene vinyl ether) (POEVE), polymeric alcohols, hydroxypropyl acrylate, hydroxypropyl methylcellulose, hydroxypropyl cellulose, methylcellulose, poly(vinyl alcohol) and derivatives, polyamides, poly(N-vinyl pyrrolidone), poly(ethyl oxazoline), poly(N-vinylisobutylamide) (PNVIBA), poly(2-carboxyisopropylacrylamide) (PCIPAAm), poly(methacrylic acid), artificial polypeptides, triblock co-polypeptides that consist of short “leucine zipper” end blocks, elastin-like polypeptides (ELPs), and poly(N-isopropylacrylamide). As will be appreciated, these materials may be provided as homopolymers or copolymers formed from two, three or four monomeric materials.

In additional or alternative embodiments, the temperature-sensitive polymeric material may be selected from one or more of the group consisting of a poly(N-vinylamide) and a polyacrylic acid, or a derivative of a polyacrylic acid.

Examples of poly(N-vinylamides) include, but are not limited to poly(N-vinyl pyrrolidone), poly(N-vinylisobutylamide) (PNVIBA), poly(2-carboxyisopropylacrylamide), and copolymers thereof. Examples of polyacrylic acids include, but are not limited to polyacrylic acid, poly(methacrylic acid) and copolymers thereof. Examples of polyacrylic acid derivatives include, but are not limited to polyacrylamides. Particular polyacrylamides that may be mentioned herein include, but are not limited to, poly(N-isopropylacrylamide), poly(N,N-diethylacrylamide) and copolymers thereof.

In particular embodiments of the invention, that may be mentioned herein, the temperature-sensitive polymeric material is poly(N-isopropylacrylamide).

A composite material according to the invention that may be mentioned herein may be one in which the water-stable metal-organic framework is MIL-101(Cr) and the temperature-sensitive polymeric material is poly(N-isopropylacrylamide).

The temperature-sensitive polymeric material may contribute any suitable amount to the total dry weight of the composite material. For example, the temperature-sensitive polymeric material may form from 20 to 95 wt % of the total dry weight of the composite material, such as from 38 to 85 wt %.

The composite materials disclosed herein may be able to adsorb substantial amounts of water. For example, the composite material may be able to adsorb a maximum of from 100 to 440 wt % of water relative to the dry weight of the composite material when exposed to saturated humid air conditions for a period of 24 hours.

Thus, in a second aspect of the invention, there is provided a use of a composite material as described hereinbefore for adsorption and release of water. For example, the use may be directed towards the adsorption of atmospheric water and the release of water as shown in Example 3.

In a further aspect of the invention, there is disclosed a method of obtaining water from the atmosphere, comprising the steps of:
(a) providing a composite material as described hereinbefore to ambient atmospheric conditions for a period of time to adsorb water from the atmosphere; and
(b) heating the composite material to a temperature of from 5 to 20° C. above the lower critical solution temperature of the temperature-sensitive polymeric material to obtain water.

In embodiments of the method, the heating in step (b) may be from 7 to 15° C. above the lower critical solution temperature of the temperature-sensitive polymeric material.

It has been surprisingly found that the composite materials of the current invention have high water uptake capacity, and can be regenerated at a relatively low temperature, which is more energy efficient. As shown in Example 3, the composite materials of the current invention can capture an exceptional amount of water (ca. up to 440 wt. %) under a relative humidity (RH) of 96% at 25° C. In addition, the composite materials can release 98% of the adsorbed water and be regenerated at a relatively milder condition (40% RH and 40° C.).

Without wishing to be bound by theory, the formation of the polymeric chains within the cavity of the metal-organic framework described herein provides the necessary physical and chemical properties (i.e. porosity, functional groups etc), to allow the trapping and storage of atmospheric water. Further, the use of a temperature-sensitive polymeric material with a suitable lower critical solution temperature (in the current composite materials) allows a low regeneration temperature to be achieved for various water capture and/or release applications.

Further aspects and embodiments of the invention will now be described by reference to the following non-limiting examples.

### EXAMPLES

Materials

All the chemicals and reagents are commercially available and used as received without purification. Chromium (III) nitrate nonahydrate [Cr(NO₃)₃·9H₂O], benzene-1,4-dicarboxylic acid (BDC), and azobisisobutyronitrile (AIBN) were purchased from Sigma-Aldrich and used without further purification. N-isopropylacrylamide (NIPAM) was purchased from TCI. Anhydrous methanol (99.8%), tetrahydrofuran (THF, HPLC grade), N,N-dimethylformamide (DMF, HPLC grade), acetone (HPLC grade), ethanol (EtOH, HPLC grade) and dichloromethane (DCM, 99.8%) were obtained from Fisher Scientific.

Characterisation Methods

Fourier transform infrared spectroscopy (FTIR) data were collected with a Bio-Rad FTS 3500 spectrometer under the attenuated total reflection (ATR) mode. X-ray photoelectron spectroscopy (XPS) spectra were collected on a Kratos AXIS Ultra DLD surface analysis instrument using a monochromatic Al K_{α} radiation (1486.71 eV) at 15 kV as the excitation source. The take-off angle of the emitted photoelectrons was 90° (the angle between the plane of sample surface and the entrance lens of the detector). Peak position was corrected by referencing the C 1s peak position of adventitious carbon for a sample (284.6 eV), and shifting all other peaks in the spectrum accordingly.

¹H-NMR experiments were performed on a Bruker 400 MHz spectrometer. The molecular weight and molecular weight distribution (polydispersity index, PDI) of the as-made PNIPAM and the extracted PNIPAM from the composites were determined using a Waters e2695 Alliance system with Waters 2414 RI detector Styragel HR 4 column. THE was used as the eluent with a flow rate of 1 mL min⁻¹. Polystyrene (PS) standards were used for calibration. Thermogravimetric analyses (TGA) were performed under air atmosphere using a Shimadzu DTG-60AH instrument. Differential scanning calorimetry (DSC) was performed using a Mettler Toledo DSC1 instrument at a temperature range of 20-60° C. with a heating rate of 5° C. min⁻¹ and a cooling rate of 3° C. min⁻¹. The crystallinity and phase purity of MIL-101(Cr) and composites were confirmed by X-ray diffraction (XRD) patterns, which were collected on a Rigaku MiniFlex X-ray diffractometer at a scan rate of 0.02 deg s⁻¹.

The morphologies of MIL-101(Cr) and composites were characterised by field emission scanning electron microscopy (FESEM, FEI Quanta 600) and transmission electron microscopy (TEM, JEOL-JEM 2010F). The corresponding elemental mapping from SEM was conducted using an energy dispersive spectrometer (EDS, Oxford Instruments, 80 mm² detector).

The N₂ sorption isotherms at 77 K and water sorption isotherms at 298 K were obtained using a Micromeritics ASAP 2020 physisorption analyzer. Before each measurement, the sample (˜50 mg) was degassed under a reduced pressure (<10⁻² Pa) at 150° C. for 12 h. The water sorption isotherms at 313 K were obtained using a Quantachrome Aquadyne dynamic vapor sorption analyzer.

General Method 1—Synthesis of MIL-101(Cr)

The microwave-assisted synthesis of MIL-101 was conducted based on a previous report (L, Bromberg, et al., Chem. Mater. 2012, 24, 1664-1675). Briefly, Cr(NO₃)₃·9H₂O (4.5 mmol, 1.80 g) was dissolved in deionised water (DI, 13.5 mL). The homogeneous dark blue solution was introduced into a microwave vial followed by the addition of HNO₃ solution (1 M, 4.5 mL). Finally, benzene-1,4-dicarboxylic acid (BDC, 4.5 mmol, 0.747 g) was transferred into the vial together with a stirrer bar. The suspension was briefly agitated to ensure homogeneity. The reaction mixture was capped and heated to 205° C. within 5 min in a microwave synthesiser (Anton Paar MW450), and subsequently held at that temperature for 45 min under stirring (800 rpm). After the reaction, the product was cooled to 70° C. under forced convection. After removing the excessive BDC crystals by filtration, the fine powder of MIL-101(Cr) was recovered by centrifugation, and washed with H₂O (1×50 mL) followed by absolute EtOH (2×50 mL).

Activation was performed according to the previously reported method (D. Y. Hong, et al., Adv. Funct. Mater. 2009, 19, 1537-1552). Briefly, the MOF powder was soaked in water at 70° C. for 5 h, and then in EtOH at 60° C. for 3 h. Finally, it was dried overnight under vacuum at ambient temperature.

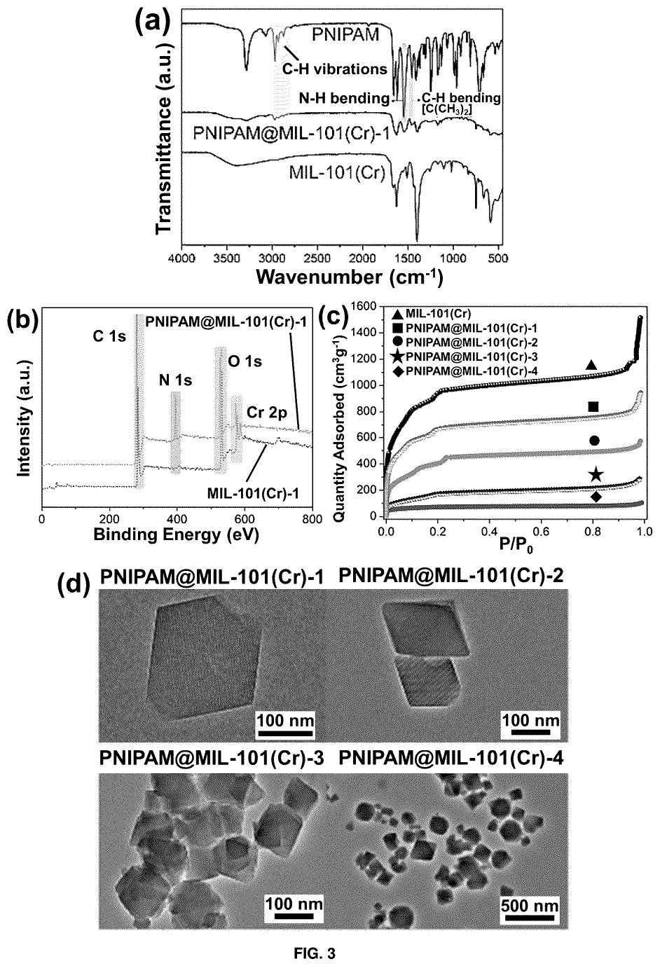

The as-prepared and activated MIL-101(Cr) was characterised accordingly with its phase-purity and porosity confirmed by powder X-ray diffraction (PXRD), Fourier transform infrared spectroscopy (FTIR), thermo-gravimetric analysis (TGA), and gas sorption measurement (see FIGS. 3a-c, 4a, 5 and 9).

### Example 1. Synthesis and Characterisation of PNIPAM@MIL-101(Cr) of the Current Invention

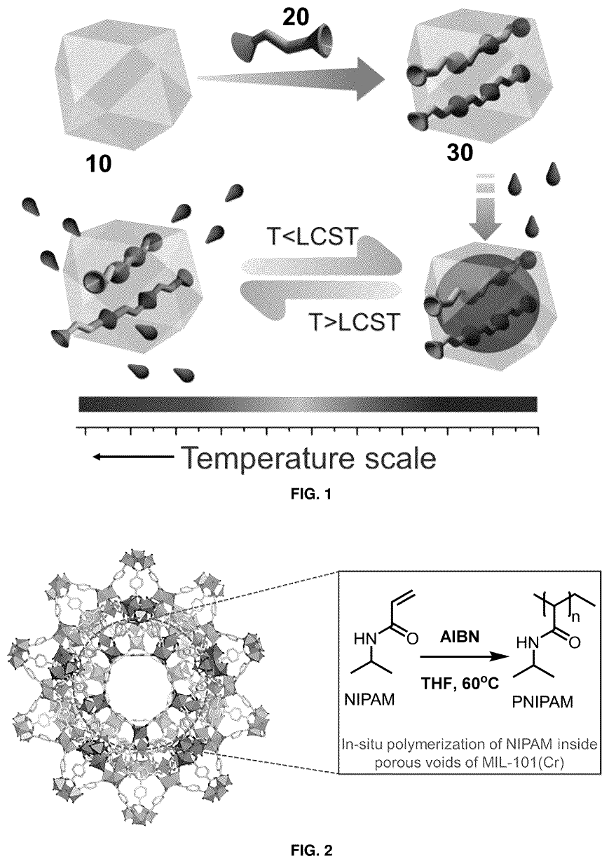

The MOF/polymer composite material 30 of the current invention (denoted as PNIPAM@MIL-101(Cr)) was synthesised by polymerisation of suitable monomeric polymer precursor 20 within the voids of a suitable porous MOF 10 (FIGS. 1 and 2). In this example, MIL-101(Cr) as-synthesised from “General Method 1” was selected as the MOF, and N-isopropylacrylamide (NIPAM) was selected as the monomeric polymer precursor.

Experimental Procedures

MIL-101(Cr) (ca. 300 mg) was degassed under vacuum overnight at 150° C. Various amounts of NIPAM (Table 2) dissolved in diethyl ether (10 mL) was taken and gently stirred with the MOF to form a uniform suspension. The solvent was then evaporated under reduced pressure, and AIBN (0.3 equivalents/NIPAM) in anhydrous THE (10 mL) was introduced. The content of the round bottom flask was then sealed and left to react at 60° C. for 48 h. After the completion of the reaction, the composites were then rinsed thoroughly with hot methanol, hot acetone, hot DCM before degassing at 80° C. overnight. The multiple steps of washing can purify the composites by removing the undesired starting materials and oligomers away from the surface of the MOF crystals.

Results and Discussion

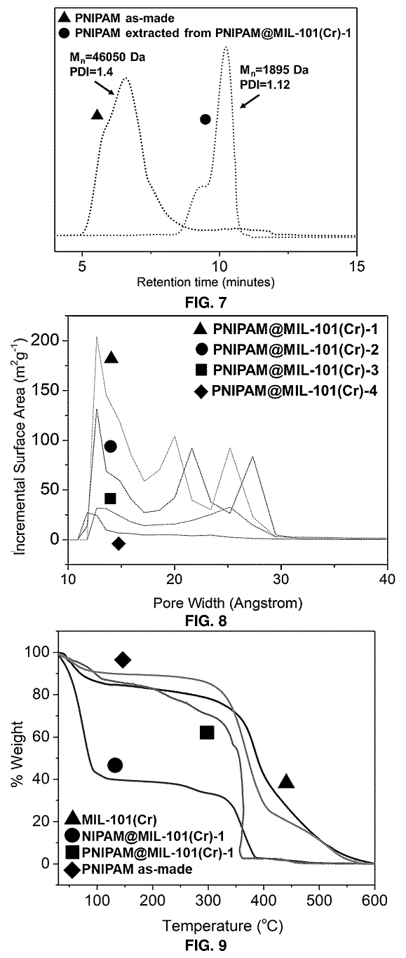

The NIPAM monomer was loaded in activated MIL-101(Cr) at various weight percentages (Table 2), and free radical polymerisation was initiated using azobisisobutyronitrile (AIBN) as the initiator (FIG. 2). The completion of the polymerisation inside MIL-101(Cr) was monitored by ¹H-NMR spectroscopy (FIG. 6) and gel permeation chromatography (GPC, FIG. 7). The resulting composite materials PNIPAM@MIL-101(Cr) were prepared with four different PNIPAM contents, namely PNIPAM@MIL-101(Cr) 1-4.

TABLE 2
Loading % of NIPAM (as compared to the mass of the activated
MOF host) and the corresponding loading % of the PNIPAM (as
calculated from elemental analyses) of PNIPAM@MIL-101(Cr).

| | NIPAM | Experimental | | PNIPAM |
|---|---|---|---|---|
| | Loading | Elemental % | | Loading |
| Sample | (%) | Carbon | Nitrogen | (%) |
| PNIPAM@MIL-101(Cr)-1 | 92 | 45.32 | 3.22 | 38 |
| PNIPAM@MIL-101(Cr)-2 | 110 | 46.64 | 3.54 | 45 |
| PNIPAM@MIL-101(Cr)-3 | 166 | 49.11 | 4.88 | 65 |
| PNIPAM@MIL-101(Cr)-4 | 185 | 50.66 | 5.5 | 85 |

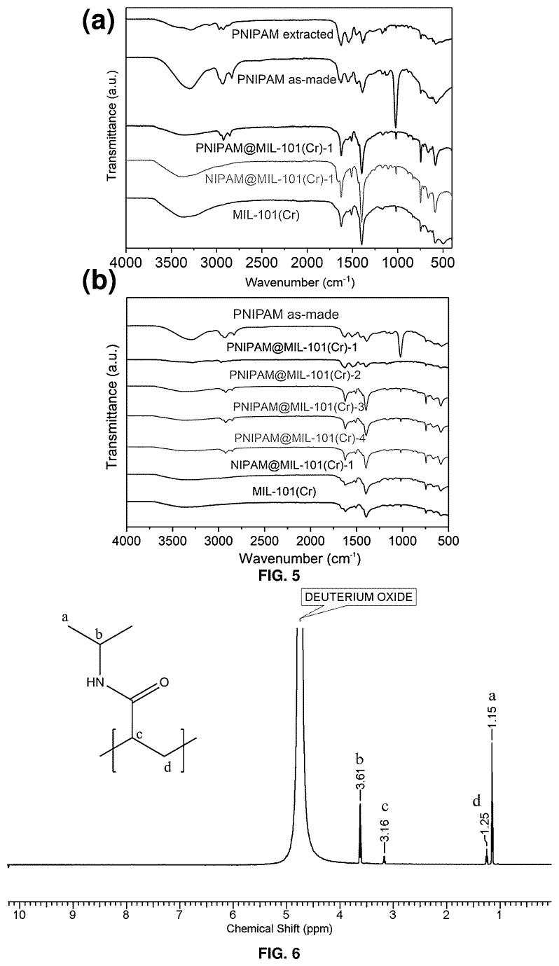

The PNIPAM loading contents determined by elemental analyses are 38, 45, 65, and 85 wt. % for PNIPAM@MIL-101(Cr) 1-4, respectively (Table 2). Peaks corresponding to the C—H stretching of PNIPAM backbone at 2900 cm⁻¹, N—H bending of PNIPAM amide group at 1550 cm⁻¹, and C—H bending of PNIPAM isopropyl group at 1460 cm⁻¹ were observed in the FTIR spectra of all PNIPAM@MIL-101(Cr) samples, confirming the formation of PNIPAM in the composites (FIGS. 3a, 5a and 5b).

The X-ray photoelectron spectroscopy (XPS) spectra of the composites show peaks of N (1s) coming from PNIPAM component (FIG. 3b). Characteristic peaks of the polymer can be observed in the ¹H-NMR spectrum of the PNIPAM extracted from PNIPAM@MIL-101(Cr)-1 (FIG. 6), reiterating that PNIPAM was successfully formed inside MIL-101(Cr) via in-situ polymerisation. The GPC result of the extracted PNIPAM suggests a number averaged molecular weight (Mₙ) of 1895 (ca. 17 repeating monomer units in one polymeric chain) with a polydispersity index (PDI) of 1.12 (FIG. 7, Table 3). This molecular weight is lower than that of PNIPAM synthesised in bulk (46050), indicating a confinement effect exerted by MIL-101(Cr) host during the in-situ polymerisation.

TABLE 3
Mₙ, M_{w} and PDI values of PNIPAM calculated
from GPC data of as-made PNIPAM and PNIPAM
extracted from PNIPAM@MIL-101(Cr)-1.

| Sample | Mₙ | M_{w} | PDI |
|---|---|---|---|
| PNIPAM (as-made) | 46050 | 64470 | 1.4 |
| PNIPAM (extracted from | 1895 | 2122 | 1.12 |
| PNIPAM@MIL-101(Cr)-1) | | | |

In addition, the N₂ sorption isotherms at 77 K reveal a Brunaeur-Emmet-Teller (BET) surface area (S_{BET}) of ca. 3200 m² g⁻¹ for MIL-101(Cr), while the S_{BET} of the composites were determined as 2200, 1505, 641, and 227 m² g⁻¹ for PNIPAM@MIL-101(Cr) 1-4, respectively (FIG. 3c). This decreasing order in S_{BET} is consistent with the increase of the PNIPAM content from composite 1 to 4, evidencing that the polymer is confined in the pores of MIL-101(Cr). This conclusion is further supported by the pore size distribution data, confirming that larger pores of MIL-101(Cr) are gradually blocked by PNIPAM at higher polymer contents and only the smaller pores are accessible (FIG. 8).

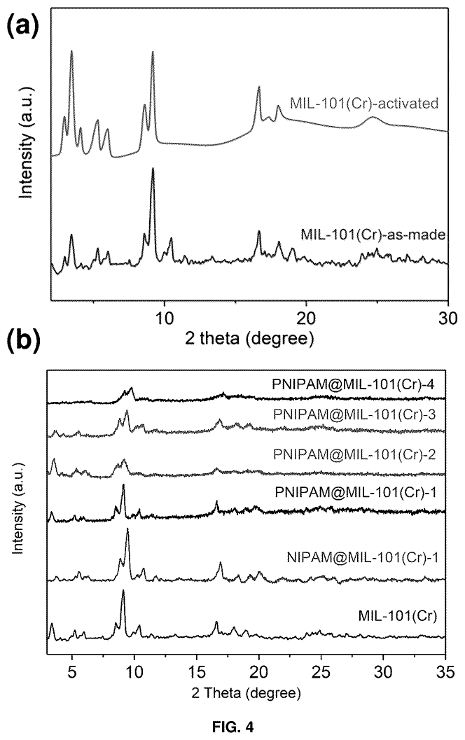

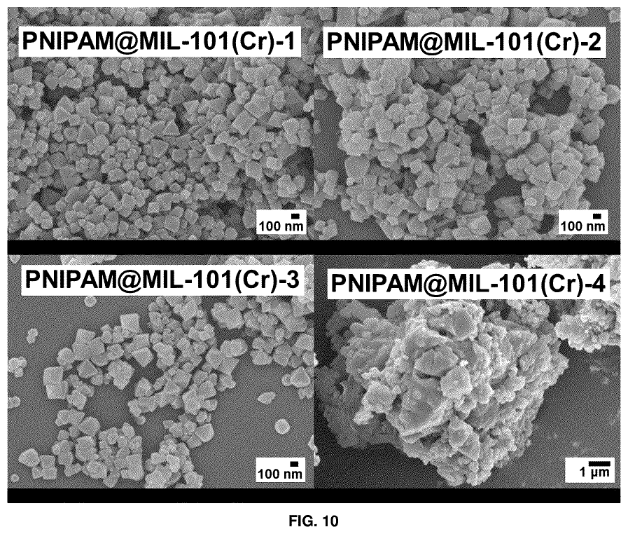

The TGA profile of PNIPAM@MIL-101(Cr)-1 shows a steady weight loss corresponding to the decomposition of the PNIPAM in the composite (FIG. 9). The crystal structure and morphology of MIL-101(Cr) remain unaltered after monomer loading and polymerisation, as suggested by PXRD (FIG. 4b), scanning electron microscopy (SEM, FIG. 10), and transmission electron microscopy (TEM, FIG. 3d). The sharp edges and the perfectly crystalline morphological integrity indicate that PNIPAM formed outside of MIL-101(Cr), if any, has been completely removed during the purification procedure.

As will be appreciated, the polymeric chains of PNIPAM may be entirely contained within a cavity of the MIL-101(Cr). However, in other cases (especially with higher loading of the polymer), a polymer chain may be partly housed within one cavity of the MIL-101(Cr) and extend out from that cavity, and/or may extend through one cavity and into at least one further cavity in the same or neighbouring MIL-101(Cr).

### Example 2. Water Sorption Isotherms of the Composite Materials of the Current Invention

The water uptake and release properties of the composite materials of the current invention (in Example 1) were first evaluated at various humidity and temperatures using a vapor sorption analyzer.

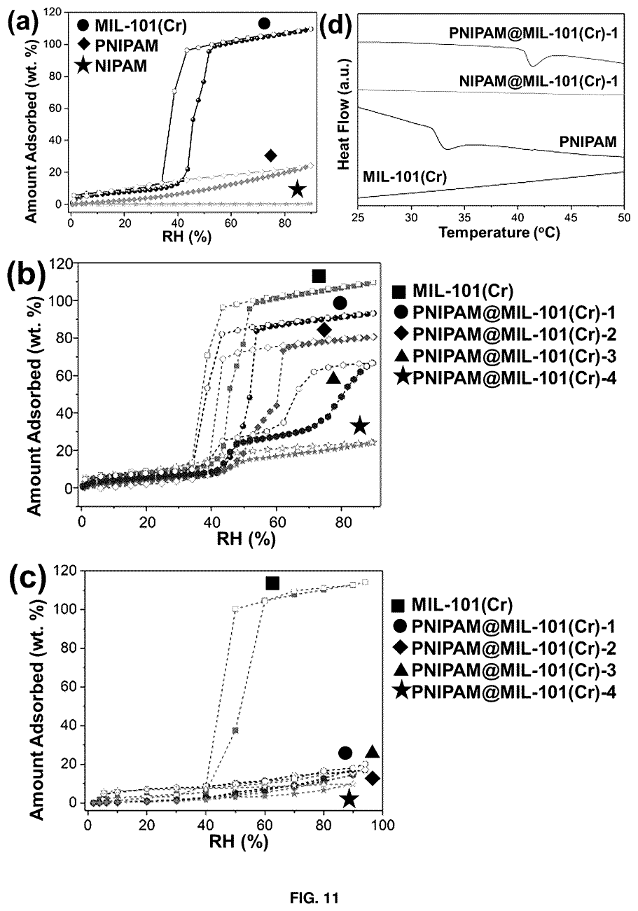

Water sorption isotherms were collected as preliminary evaluations for water uptakes under near-saturated conditions (see “characterisation methods” above). The water sorption isotherm of MIL-101(Cr) collected at 25° C. shows a typical “S” shape with a high uptake capacity of ca. 110 wt. % at 90% RH and a hysteresis between adsorption and desorption branches, matching well with the reported result (FIG. 11a) (G. Akiyama, et al., Microporous Mesoporous Mater. 2012, 152, 89-93).

Although PNIPAM is highly hydrophilic at temperatures below its LCST, its water uptake is significantly low at 90% RH (22 wt. % at 25° C., FIG. 11a). This can be attributed to its non porous structure that causes a substantial diffusion resistance for water molecules.

On the contrary, water uptakes of the composites of the current invention are all higher than that of PNIPAM under the same condition (90% RH and 25° C.), while showing a decreasing trend when the polymer content increases, i.e., 93 wt. % for composite 1, 79 wt. % for composite 2, 65 wt. % for composite 3, and 24 wt. % for composite 4 (FIG. 11b). This observation is consistent with the progressive blocking of the MOF pores when the PNIPAM loading increases. The typical “S” shaped water sorption isotherm of pristine MIL-101(Cr) is maintained in the composites, making them attractive for atmospheric water generators (AWG) applications.

Interestingly, the polymer content allows a tuning of the hydrophilic/hydrophobic nature of the resulting composites as evidenced by a progressive shift of the initial stage of water adsorption towards higher RHs when the polymer loading increases (FIG. 11b). Notably, the water sorption isotherms collected at 40° C. suggest a similar behaviour of MIL-101(Cr) but much lower water uptakes of the composites (FIG. 11c), which can be attributed to the hydrophilic-to-hydrophobic phase transition of the PNIPAM component in the composite. This was further validated by differential scanning calorimetry (DSC) experiments, in which an endothermic peak representing LCST at ca. 40° C. was observed in the pre-wetted PNIPAM@MIL-101(Cr)-1 during the heating cycle, while a similar peak for pre-wetted pure PNIPAM appears at ca. 33° C. (FIG. 11d). The increased LCST of the composite as compared to that of the pure PNIPAM can be ascribed to the combination of the confinement effect and the hydrophobic interactions between PNIPAM and the MOF host.

### Example 3. Atmospheric Water Harvesting Properties of the Composite Materials of the Current Invention

To evaluate the atmospheric water harvesting (AWH) properties of the composite materials of the current invention (in Example 1), the composite materials were tested in a humidity chamber, which mimicked wet and dry environments for water uptake and release, respectively.

Experimental Procedures

The water uptake and release experiments were carried out using a Labec QHT-30 temperature and humidity chamber with a relative humidity (RH) range of 25-98% and a temperature range of 20-120° C. Firstly, the sample was activated by heating under vacuum at various temperatures (150° C. for MOF, 120° C. for composites) for 12 h to fully remove any adsorbed moisture. After activation, the sample was incubated in the humidity chamber under various RHs and temperatures to reach equilibrium with moisture. The sample weights before and after incubation in the humidity chamber were recorded, and the water uptake wt. % was calculated according to eq. 1 below,

$$( \frac{{W}_{s} - {W}_{o}}{{W}_{o}} ) \times 100 \% \qquad Equation 1$$

where
Wₒ=Initial weight of the activated sample
Wₛ=Final weight of the sample after incubation in the humidity chamber

Results and Discussion

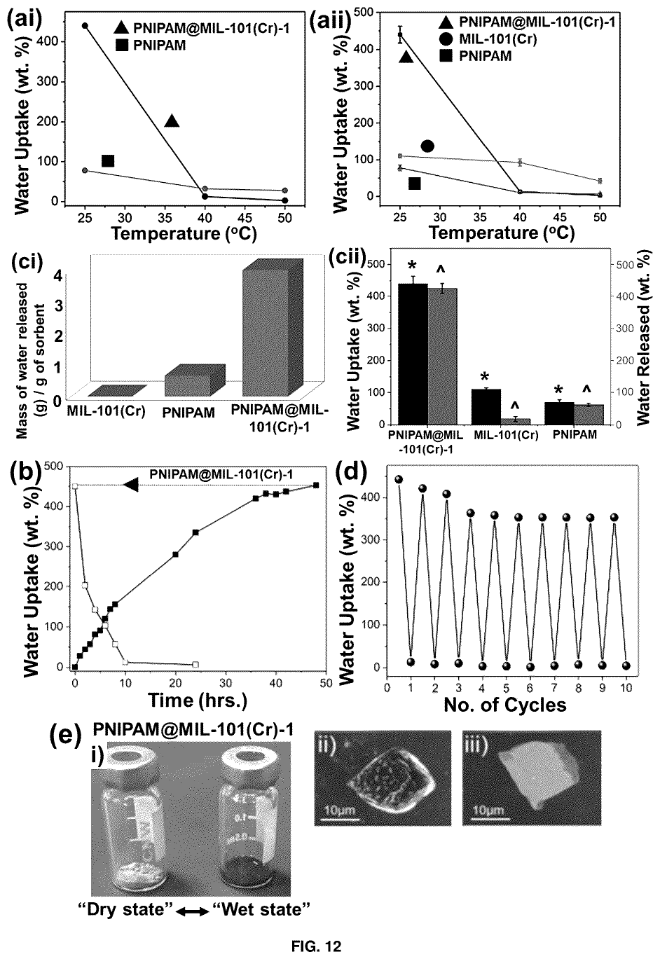

A humidity chamber was used to emulate the super saturated “wet state” for water uptake, in which the samples were exposed to high humidity (96% RH) at 25° C. without any direct contact with liquid water. Surprisingly, PNIPAM@MIL-101(Cr)-1 exhibited a remarkable water uptake of ca. 440 wt. % (FIGS. 12ai and ii for initial and finalised data, respectively), which is 373% higher than that determined from water sorption isotherm under 90% RH at 25° C. (93 wt. %).

Under the same experimental conditions, MIL-101(Cr) and PNIPAM exhibited only around 110 and 74 wt. % water uptakes, respectively (FIG. 12aii). The water uptake of MIL-101(Cr) determined by the humidity chamber test was almost the same as that obtained from its water sorption isotherm, while a 236% enhancement in water uptake was achieved in PNIPAM between these two tests (74 wt. % vs. 22 wt. %).

Visual inspection (and under an optical microscope) of the PNIPAM@MIL-101(Cr)-1 saturated under 96% RH at 25° C. indicates water condensation at the surface of the composite (FIGS. 12ei-iii). However, only partial wetting was observed in bulk PNIPAM under the same condition, and no wetting was observed in MIL-101(Cr) at all. This is because MIL-101(Cr) is mainly hydrophobic (as can be seen from its “S” shaped water sorption isotherm) without ample strong interacting sites with water. Therefore, it remained dry during the tests without much water uptake difference between humidity chamber test and water sorption isotherm.

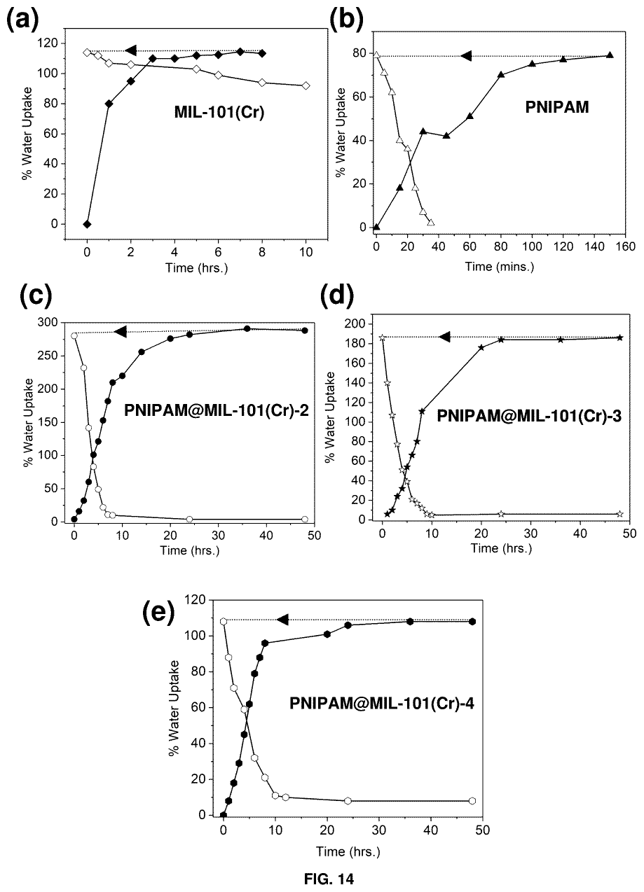

On the other hand, the hydrophilic amide groups of PNIPAM exposed on the bulk polymer surface are able to form extensive hydrogen bond interactions with the water molecules from the humid atmosphere, causing initial surface wetting. However, the diffusion resistance of moisture caused by the non-porous structure of PNIPAM retarded complete wetting of the bulk polymer, which can be seen from the plateau region of its water uptake kinetics data before reaching equilibrium (FIG. 14b). Such a diffusion resistance can be largely mitigated in the composites because more PNIPAM chains become accessible due to the porous MIL-101(Cr) host, so that the coil-conformed polymers inside the MOF cavities can attract more water molecules, and the MOF host acts as a perfect reservoir due to its pervious nature.

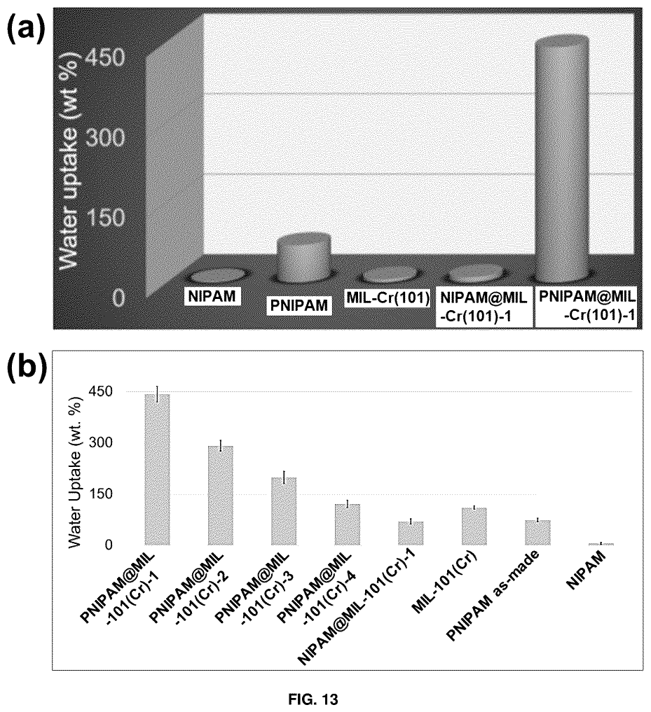

Notably, the water uptake of the composites decreases as the polymer content increases, due to the partial blocking of the MOF pores by the polymer (FIGS. 13a and b, and Table 4). It was also observed that the kinetics of water uptake in the composites is much slower than that of the MOF (FIGS. 12b, 14a-e), which can be attributed to the equilibrium time taken for the water-PNIPAM interaction as well as the inherent hydrophobic nature of the parent MOF.

In short, the enormous water uptake observed in PNIPAM@MIL-101(Cr)-1 under 96% RH at 25° C. can be ascribed to the ability of the PNIPAM chains to attract moisture from highly humid air (RH>95%) in the pores of the composites (acting as reservoirs) and onto the surface of the composites (because of the condensation effect).

TABLE 4
Water uptakes of various samples upon exposure
to 96% RH at 25° C. in a humidity chamber.

| Sample | % Water Uptake |
|---|---|
| PNIPAM@MIL-101(Cr)-1 | 440 ± 23 |
| PNIPAM@MIL-101(Cr)-2 | 291 ± 16 |
| PNIPAM@MIL-101(Cr)-3 | 198 ± 18 |
| PNIPAM@MIL-101(Cr)-4 | 121 ± 11 |
| NIPAM@MIL-101(Cr)-1 | 70 ± 8 |
| MIL-101(Cr) | 110 ± 5 |
| PNIPAM as-made | 74 ± 5 |
| NIPAM | 5 ± 3 |

A “dry state” of 40% RH at 40° C. was adopted in the humidity chamber test to study the water release process after fully saturating the samples under the “wet state”. As 40° C. is high enough to trigger the hydrophilic-to-hydrophobic phase transition of PNIPAM, the water release process can be expedited by this phase transition.

As shown in the kinetics curve (FIG. 14), the water release process of MIL-101(Cr) is very slow due to the strong water-framework interactions, resulting in only 18% of the adsorbed water being released during the test period (10 h). On the contrary, it is much faster to release the adsorbed water from PNIPAM and composites (FIGS. 12b and 14b-e). As a result, 97% and 98% of the adsorbed water can be released within 10 h from PNIPAM and PNIPAM@MIL-101(Cr)-1, respectively. The water release kinetics data strongly support that the hydrophilic-to-hydrophobic phase transition of PNIPAM triggered under relatively low temperatures can facilitate water release and adsorbent regeneration.

Further, the AWH properties of the current composite materials (in the wet and dry states mentioned above) were compared with that of MIL101(Cr). It was observed that MIL101(Cr) only delivered 17 wt. % of water, while PNIPAM@MIL-101(Cr)-1 delivered 425 wt. % of water (FIGS. 12ci and cii for initial and finalised data). The water uptake capacity of PNIPAM@MIL-101(Cr)-1 also stabilised at ca. 355 wt. % under wet state after 10 cycles of regeneration (FIG. 12d).

### Example 4. Force Field Based Molecular Dynamics (MD) Simulations of the Composite Materials of the Current Invention

To further understand the MOF/polymer composite material of the current invention and its interaction with water, force field based molecular dynamics (MD) simulations were carried out.

Experimental—Modelling Method of the MD Simulations

The MIL-101(Cr) framework model consists of a primitive cell of the crystal structure resolved previously by X-ray diffraction, containing one fluorine atom as counter-anion per Cr₃O trimer. One water molecule was coordinated to each of the remaining 2 Cr(III) atoms per Cr₃O trimer and their positions were subsequently geometry-optimized at the force-field level using the Universal force field (Dassault Systemes BIOVIA, Materials Studio, 7.0, San Diego: Dassault Systemes. 2019).

The PNIPAM model was constructed with a polymer chain containing 17 NIPAM repeating units, which is in accordance with the GPC profile experimentally obtained in this work. This polymerisation was achieved at the force field level following the same computational strategy reported previously for other polymers (T. Uemura, et al., Nat. Commun. 2010, 1, doi: 10.1038/ncomms1091). The resulting polymer was further incorporated randomly into the pores of MIL-101(Cr) in order to create three distinct PNIPAM@MIL-101(Cr) composite systems containing 10, 15, and 20 molecules of PNIPAM per MIL-101(Cr) unit cell corresponding to PNIPAM mass concentrations of 39.4, 59.0, and 78.7 wt. %, respectively, which can match the values of polymer loading explored experimentally (38, 45, 65, and 85 wt. %). In addition, a fourth composite was built with 5 PNIPAM chains per unit cell (19.7 wt. %) to model a scenario of a very low loading of polymer in the MOF.

The interatomic interactions were represented by van der Waals and electronic contributions represented respectively by 12-6 Lennard-Jones (LJ) and Coulombic potentials. The 12-6 LJ parameters of the MIL-101(Cr) framework were taken from the generic force-fields DREIDING and UFF to describe the atoms of the organic and inorganic nodes, respectively (S. L. Mayo, et al., J. Phys. Chem. 1990, 94, 8897-8909; and A. K. Rappe, et al., J. Am. Chem. Soc. 1992, 114, 10024-10035). The charges assigned to the coordinated water molecules were taken from the SPC/E model while the charges attributed to the remaining atoms of the framework were obtained from the literature (M. De Lange, et al., J. Phys. Chem. C. 2013, 117, 7613-7622). The bonded and non-bonded parameters assigned to each atom of PNIPAM were taken from the OPLS-AA force-field (W. L. Jorgensen, et al., J. Am. Chem. Soc. 1996, 118, 11225-11236).

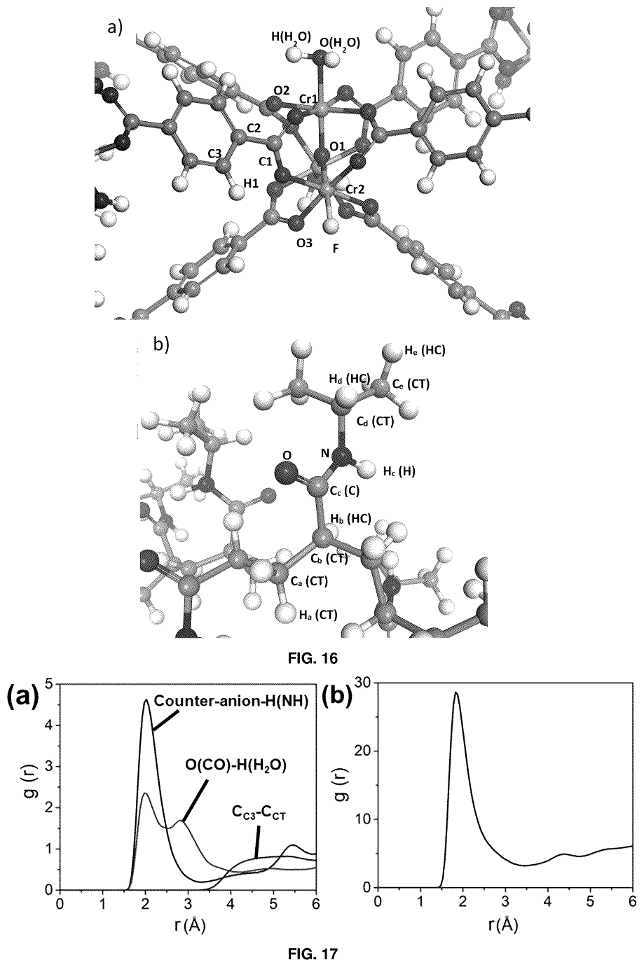

The charges of the polymer were calculated at the DFT level employing the B3LYP functional combined with a double numerical basis set containing polarisation functions (DNP), as implemented in the Dmol³ module (P. J. Stephens, et al., J. Phys. Chem. 1994, 98, 11623-11627; B. Delley, J. Chem. Phys. 2000, 113, 7756-7764). The atomic labels and corresponding charges are reported in FIGS. 16a and b, and Table 5 respectively. Water was described by the SPC/E representation, with a O—H bond length of 1 Å and a H—O—H angle of 109.47°. The combination of the models used to describe both PNIPAM and water (OPLS-AA and SPC/E force-fields respectively) as well as water and MIL-101(Cr) has been proved previously to accurately describe the water-PNIPAM interactions and the water-MIL-101(Cr) interactions, respectively (J. Waltera, et al., Fluid Phase Equilibria. 2010, 296, 164-172).

TABLE 5
Atomic partial charges considered for each atom type of the
MIL-101(Cr) framework, PNIPAM chains, and water molecules.

| | | | |
|---|---|---|---|
| Atom type | q (e) | Atom type | q (e) |

| | |
|---|---|
| MIL-101(Cr) | PNIPAM |

| | Cr1 | 1.619 | Cₐ | −0.389 |
|---|---|---|---|---|
| | Cr2 | 1.350 | C_{b} | −0.215 |
| | C1 | 0.496 | C_{c} | 0.663 |
| | C2 | −0.070 | C_{d} | 0.671 |
| | C3 | −0.058 | Cₑ | −0.717 |
| | O1 | −0.853 | Hₐ | 0.150 |
| | O2 | −0.574 | H_{b} | 0.129 |
| | O3 | −0.438 | H_{c} | 0.364 |
| | O(H₂O) | −0.8476 | H_{d} | 0.018 |
| | H(H₂O) | 0.4238 | Hₑ | 0.190 |
| | H1 | 0.108 | O | −0.565 |
| | | | N | −0.682 |
| Water | | | | |
| | O_{w} | −0.8476 | | |
| | H_{w} | 0.4238 | | |

The PNIPAM@MIL-101(Cr) systems were investigated as anhydrous and fully water-saturated states. The anhydrous systems were first geometry-optimized and served as starting points to insert water using Monte Carlo calculations in the canonical ensemble. The water loading was fixed to be close to the experimental water uptakes of PNIPAM@MIL-101(Cr) 1-4 obtained by water sorption isotherms at 25° C. Therefore, to the PNIPAM@MIL-101(Cr) containing 19.7, 39.4, 59.0, and 78.7 wt. % of PNIPAM were respectively added 2600 (96.2 wt. %), 2450 (90.7 wt. %), 1810 (67 wt. %), and 900 (33.3 wt. %) water molecules per unit cell.

Molecular Dynamics (MD) simulations were further performed for both anhydrous and fully water-saturated scenarios using the DL_POLY program in the NVT ensemble using the Berendsen anisotropic thermostat with a time constant set to 1 ps (I. T. Todorov, et al., J. Mater. Chem. 2006, 16, 1911-1918; D. Frenkel, B. Smit, Understanding Molecular Simulation; Academic Press: New York, 1996). A timestep of 1 fs was used to solve the Newton's equations of Motion. The systems were equilibrated for 1 ns and then MD runs were carried out at 298 K for 20 ns. A spherical cut-off of 12 Å was used to evaluate the LJ potentials while electrostatic interactions were assessed using the Ewald summation method with a 10⁻⁶ tolerance.

The mean square displacements (MSD) for water were calculated with the use of a multiple time origin approach and plotted as a function of time. The Einstein's relation (eq. 2) was further applied to extract the values of the self-diffusion coefficients (Dₛ).

$${D}_{s} = \frac{1}{6} {lim}_{t \to ∞} \frac{1}{t} 〈 {\vert {r}_{i} ( t ) - {r}_{i} ( 0 ) \vert}^{2} 〉 \qquad Equation 2$$

The calculation of the hydrogen-bonds was performed using two geometric criteria: distance between a donor (D) and an acceptor (A) atoms shorter than 3.5 Å, and angle between the D-H vector and the D-A vector lower than 37°. These criteria are the same as those previously used to describe the hydrogen-bond network in other materials (P. G. M. Mileo, et al., J. Am. Chem. Soc. 2018, 41, 13156-13160).

Results and Discussion

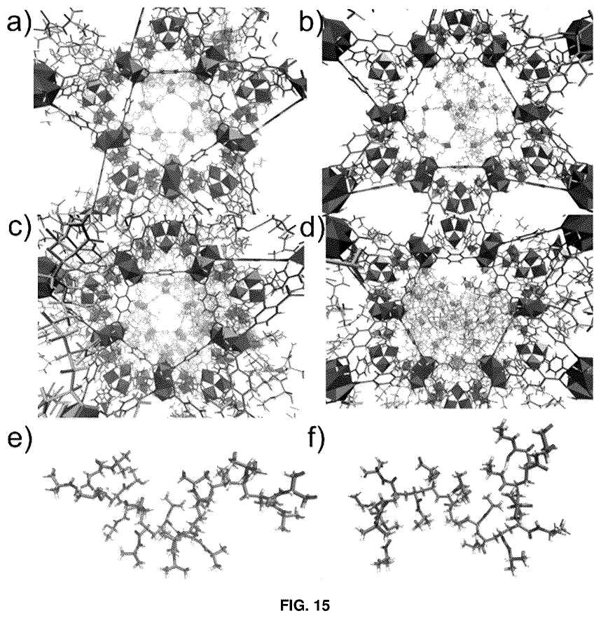

Force field based molecular dynamics (MD) simulations were performed to gain further insight into the MOF/polymer composites at the atomistic scale. The arrangements of PNIPAM chains in the pores of the MIL-101(Cr) for low (19.7 wt. %) and intermediate (59.0 wt. %) polymer contents were thus simulated (FIG. 15).

These loadings were selected to monitor the predominant MOF-polymer interacting sites at low polymer concentrations, and to reveal the preferential arrangement of the confined polymers where they still have a certain degree of freedom. In both cases, PNIPAM chains preferentially occupy the large cages (FIGS. 15b and d) rather than the small cages (FIGS. 15a and c) of MIL-101(Cr) in the vicinity of pentagonal windows. For composite with a higher polymer content, a similar preferential distribution of the polymers was observed, although they start to occupy the smaller mesoporous cages of the MOF.

The molecular interactions within PNIPAM@MIL-101(Cr) systems were further characterised by the radial distribution functions (RDFs) calculated for the MOF/polymer atom pairs (FIGS. 17a and b) at low (19.7 wt. %) PNIPAM content. As observed from the simulation results, PNIPAM interacts with MIL-101(Cr) mostly through hydrogen bonds formed between the amide groups of PNIPAM and the inorganic node of the MIL-101(Cr) framework. These hydrogen-bonds are formed between the carbonyl (CO) oxygen atoms of PNIPAM and the coordinated water molecules of MIL-101(Cr) as well as between the —NH moieties of PNIPAM and the counter anions of MIL-101(Cr). Additional weaker interactions were evidenced between the carbon atoms of the PNIPAM backbone (C_{CT}) and the organic linker of the MOF (C_{C3}), as shown by a low intensity RDF peak at ca. 4.5 Å (FIG. 17a). Furthermore, the predominant interactions between PNIPAM chains involve the —CO and —NH moieties of the amide groups with a characteristic distance of 1.9 Å (FIG. 17b).

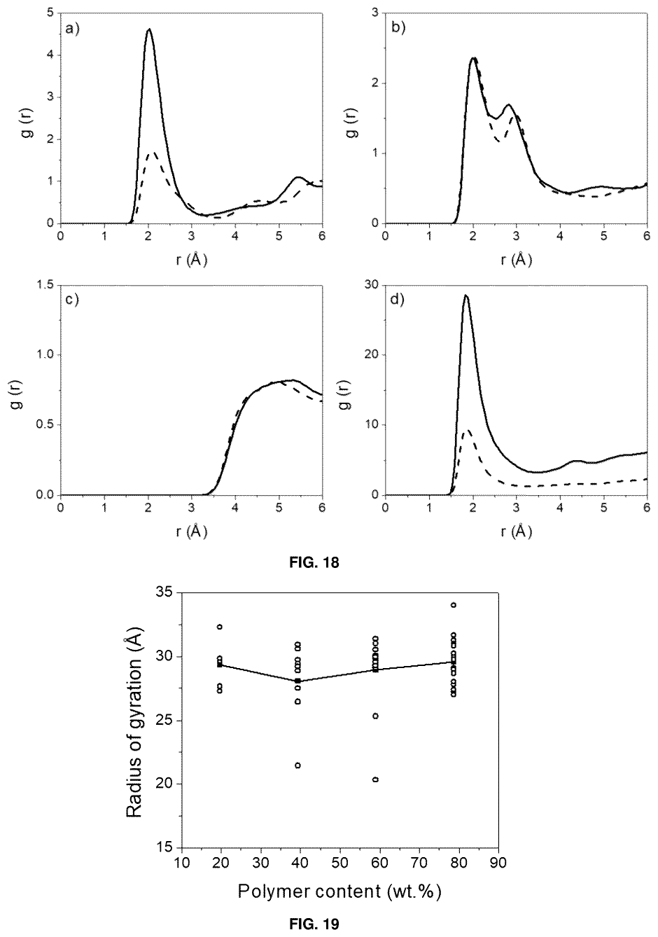

FIGS. 18a-d show that these interactions remain similar for composite with a higher polymer content. A careful inspection of the MD snapshots reveals that the PNIPAM chains adopt preferentially a linear conformation, although some of them are curled resulting from the confined environment of the MOF cages. This degree of curling for a polymer is usually correlated to its radius of gyration (ROG), in which the lower the ROG, the more curled the polymeric chains.

FIG. 19 shows that the degree of curling changes with the amount of PNIPAM loaded in the MOF. The incorporated polymer chains initially linear at low loading become gradually curled when the polymer loading increases in the range of 39.4-59.0 wt. % due to mutual polymer-polymer interactions. The polymer chains adopt packed linear conformations at the highest polymer content (78.7 wt. %) resulting from a drastic decrease of the simulated free pore volume, which was also observed experimentally (Table 6).

TABLE 6
Comparison between free volume measured experimentally and
obtained computationally in the PNIPAM@MIL-101(Cr) system.

| Theoretical | | Experimental | |
|---|---|---|---|
| Polymer content | Free volume | Polymer content | Free volume |
| (wt. %) | (cm³/g) | (wt. %) | (cm³/g) |
| 19.7 | 1.343 | 35 | 1.460 |
| 39.4 | 1.058 | 45 | 0.888 |
| 59.0 | 0.837 | 65 | 0.442 |
| 78.7 | 0.672 | 85 | 0.161 |

MD simulations were further performed to gain microscopic insight into the water/composite system and to reveal the location of water in the composites and its impact on the MOF-polymer interactions. Based on the comparison, PNIPAM@MIL-101(Cr) system containing 59.0 wt. % of PNIPAM was used, and was incorporated with water at the saturation capacity of the PNIPAM@MIL-101(Cr)-3 sample as observed experimentally (FIG. 11b).

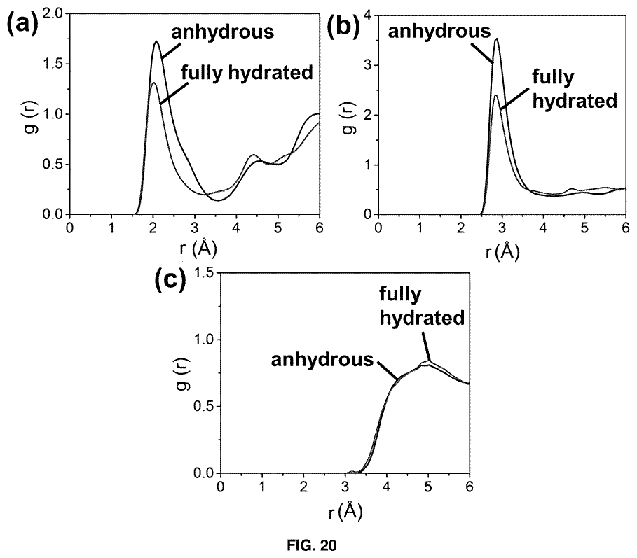

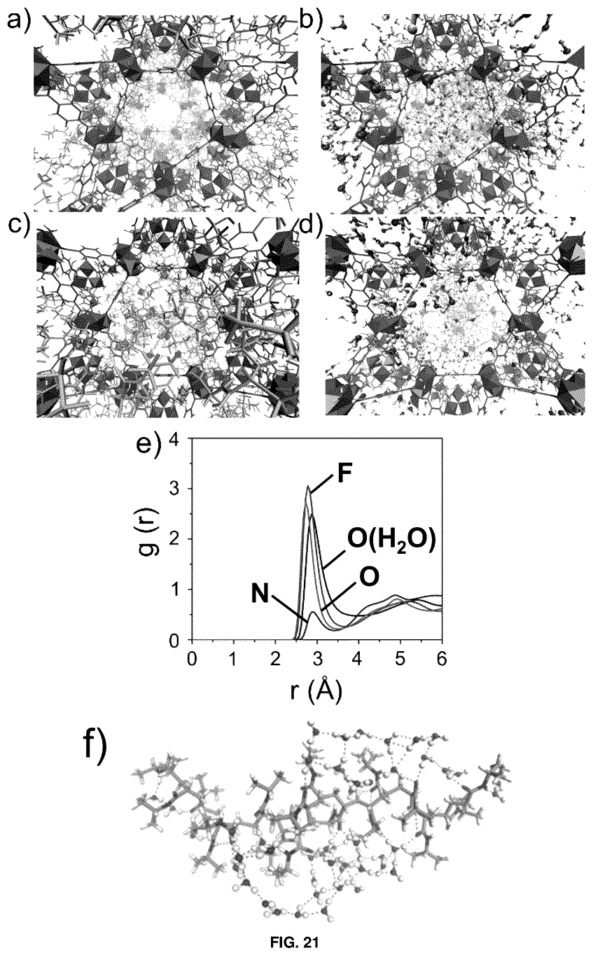

In the above system, it was observed that the H₂O molecules preferentially occupy the small cages, while both PNIPAM and H₂O coexist in the large cages (FIGS. 21c and d). It was further observed that at the highest polymer loading, the population of both cages by the PNIPAM results in few free pockets where the water molecules arrange themselves (Table 6). The interactions between the water molecules and the composites result in a significant reduction of the polar interactions between the amide groups of the polymer and the inorganic nodes of the MOF. This is supported by FIGS. 20a and b, where a slight reduction in the intensity of the RDFs associated with the O(H₂O)—O(CO) and counter anion —H(NH) atom pairs was observed. The weak van der Waals interactions between the polymer and the MOF are almost unaffected from the anhydrous to the hydrated state (FIG. 20c).

RDFs corresponding to both H₂O/PNIPAM and H₂O/MIL-101(Cr) interacting pairs are as shown in FIG. 21e for PNIPAM@MIL-101(Cr)-3. This reveals that H₂O forms hydrogen-bonds with the O-atom of the carbonyl group of PNIPAM (0.84 H-bonds per CO group with a characteristic distance of 2.7 Å) in addition to those formed with the —NH moiety in lesser extent (0.23 H-bonds/NH group with a characteristic distance of 2.9 Å), leading to an arrangement of H₂O in hydrogen bonded chains bridging amide groups of the polymer (FIG. 21f). Analogously, comparing the H₂O/MIL-101(Cr) atom pairs of FIG. 21e, it was observed that the adsorbed water molecules to interact slightly stronger with the counter anion atoms than with the coordinated water molecules. This is supported by the comparison of the RDFs of the atom pairs F—O_{w} (1.07 H-bonds per counter anion group, with a characteristic distance of 2.8 Å) and O_{w}—O(H₂O) (0.70 H-bonds per coordinated H₂O, with a characteristic-distance of 2.9 Å). Interestingly, both the first RDF peak positions and the intensity of the main interacting atom pairs for H₂O/MIL-101(Cr) and H₂O/PNIPAM are equivalent, which suggests that the water molecules interact strongly with both components of the composite.

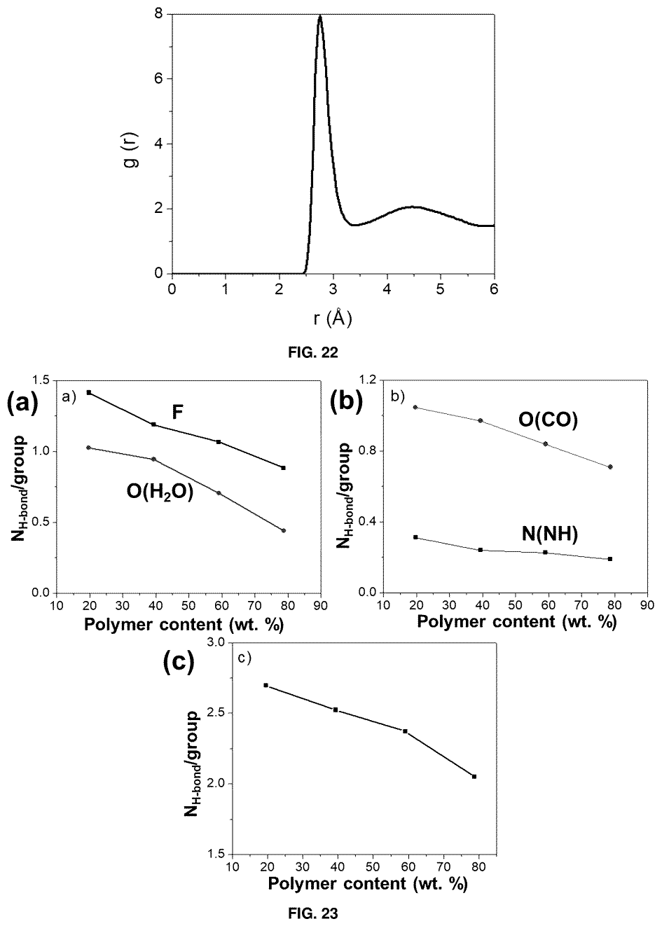

The water molecules also interact with themselves in the pores of the PNIPAM@MIL-101(Cr) composites as shown by the corresponding RDF plotted in FIG. 22 with a characteristic O_{w}—O_{w} interacting distance of 2.75 Å associated with 2.3 hydrogen-bonds of per adsorbed water molecule. Indeed, the water molecules are globally involved in multidirectional interactions inside the pores of the PNIPAM@MIL-101(Cr) composites, with a total of 2.7 hydrogen bonds per H₂O-molecule. This value is consistent with those observed in water-saturated microporous materials, but lower than the value reported for bulk water which is 3.6 (E. Dalgakiran, et al., Phys. Chem. Chem. Phys. 2018, 20, 15389-15399).

The evolution of the number of hydrogen-bonds formed between H₂O/PNIPAM, H₂O/MIL-101(Cr), and H₂O/H₂O interacting species was further investigated for composites with different polymer contents. FIG. 23 reveals that there is a significant reduction in the number of hydrogen bonds when the polymer content increases. This trend is consistent with the experimental observation of the decrease of the hydrophilicity in the composites with an increase in the polymer content (FIG. 11b). This is probably due to a continuous increase of the polymer/polymer interactions and an associated progressive entanglement of the PNIPAM chains as the polymer content increases inside the MOF framework (FIG. 24), leading to an agglomeration of the PNIPAM chains in the composite with the highest polymer content.

Lastly, the dynamics of water molecules in the composites was also explored. As the mean square displacement (MSD) is characteristic of a normal Fickian diffusion linear regime (FIG. 25), the self-diffusion coefficients (Dₛ) for water were derived using the Einstein relation (Table 7). These simulations evidence that Dₛ has a slight decrease from MIL-101(Cr) to the composites, suggesting that the mobility of water in the confined environment is not strongly affected by the packing of PNIPAM chains and water/PNIPAM interactions.

TABLE 7
Water diffusion coefficients of various water-saturated PNIPAM@MIL-
101(Cr) systems calculated from the MSD plots in FIG. 25.

| Original polymer content | Water content | Ds of water |
|---|---|---|
| (wt. %) | (wt. %) | (×10⁻¹⁰ m² · s⁻¹) |
| 0 | 110.8 | 8.19 |
| 19.7 | 96.2 | 6.12 |
| 39.4 | 90.7 | 4.97 |
| 59.0 | 67.0 | 3.07 |
| 78.7 | 33.3 | 1.40 |

1. A composite material comprising:
a plurality of water-stable metal-organic frameworks, each having a plurality of porous cavities; and
a temperature-sensitive polymeric material in the form of polymer chains, wherein the polymer chains of the temperature-sensitive polymeric material are formed at least partly within the porous cavities of the plurality of water-stable metal-organic frameworks.

2. The composite material according to claim 1, wherein each polymer chain extends through one or more of the plurality of cavities in a single metal-organic framework.

3. The composite material according to claim 1, wherein a portion of the polymer chains extend from one or more cavities in a single metal-organic framework and into one or more cavities of at least one further metal-organic framework.

4. The composite material according to claim 1, wherein at least part of one or more polymer chains occupy the same cavity of a metal-organic framework.

5. The composite material according to claim 1, wherein the water-stable metal-organic framework is formed from one or more of the group consisting of MOF-801, MOF-841, UiO-66, PIZOF-2, MIL-100(Fe), MIL-101(Al), MIL-125-NH₂, Co₂Cl₂(BTDD), Y-shp-MOF-5, and MIL-101(Cr).

6. The composite material according to claim 1, wherein the water-stable metal-organic framework is MIL-101(Cr).

7. The composite material according to claim 1, wherein the temperature-sensitive polymeric material is selected from one or more of the group consisting of polyethylene oxide (PEO), poly(ethylene oxide-co-propylene oxide) (poly(EO/PO) copolymers), PEO-PPO-PEO triblock surfactants, alkyl-PEO block surfactants, poly(vinyl methyl ether) (PVME), poly(oxyethylene vinyl ether) (POEVE), polymeric alcohols, hydroxypropyl acrylate, hydroxypropyl methylcellulose, hydroxypropyl cellulose, methylcellulose, poly(vinyl alcohol) and derivatives, polyamides, poly(N-vinyl pyrrolidone), poly(ethyl oxazoline), poly(N-vinylisobutylamide) (PNVIBA), poly(2-carboxyisopropylacrylamide) (PCIPAAm), poly(methacrylic acid), artificial polypeptides, triblock co-polypeptides that consist of short “leucine zipper” end blocks, elastin-like polypeptides (ELPs), and poly(N-isopropylacrylamide).

8. The composite material according to claim 1, wherein the temperature-sensitive polymeric material is selected from one or more of the group consisting of a poly(N-vinylamide) and a polyacrylic acid, or a derivative of a polyacrylic acid.

9. The composite material according to claim 8, wherein the poly(N-vinylamide) is selected from one or more of the group consisting of poly(N-vinyl pyrrolidone), poly(N-vinylisobutylamide) (PNVIBA), and poly(2-carboxyisopropylacrylamide).

10. The composite material according to claim 8, wherein the polyacrylic acid is selected from one or more of polyacrylic acid and poly(methacrylic acid).

11. The composite material according to claim 8, wherein the polyacrylic acid derivative is a polyacrylamide.

12. The composite material according to claim 11, wherein the polyacrylamide is selected from one or more of poly(N-isopropylacrylamide), and poly(N,N-diethylacrylamide).

13. The composite material according to claim 1, wherein the temperature-sensitive polymeric material is poly(N-isopropylacrylamide).

14. The composite material according to claim 1, wherein the water-stable metal-organic framework is MIL-101(Cr) and the temperature-sensitive polymeric material is poly(N-isopropylacrylamide).

15. The composite material according to claim 1, wherein the temperature-sensitive polymeric material forms from 20 to 95 wt % of the total dry weight of the composite material.

16. The composite material according to claim 1, wherein the composite material can adsorb a maximum of from 100 to 440 wt % of water relative to the dry weight of the composite material when exposed to saturated humid air conditions for a period of 24 hours.

17. A method for adsorption and release of water which comprises utilizing composite material as described in claim 1.

18. The method of claim 17, wherein the adsorption of water is the adsorption of atmospheric water.

19. A method of obtaining water from the atmosphere, comprising the steps of:
(a) providing a composite material according to claim 1 to ambient atmospheric conditions for a period of time to adsorb water from the atmosphere; and
(b) heating the composite material to a temperature of from 5 to 20° C. above the lower critical solution temperature of the temperature-sensitive polymeric material to obtain water.

20. The method according to claim 19, wherein the heating in step (b) is from 7 to 15° C. above the lower critical solution temperature of the temperature-sensitive polymeric material.
